(19) United States
(12) Patent Application Publication
(10) Pub. No.: US 2016/0375523 A1
(43) Pub. Date: Dec. 29, 2016

(54) LASER CLADDING WITH CARBIDE HARD PARTICLES

(71) Applicant: EATON CORPORATION, Cleveland, OH (US)

(72) Inventor: Michael Lee KILLIAN, Troy, MI (US)

(21) Appl. No.: 14/901,753

(22) PCT Filed: Jul. 1, 2014
(86) PCT No.: PCT/US14/45120

§ 371 Date: Dec. 29, 2015

Related U.S. Application Data
(60) Provisional application No. 61/842,146, filed on Jul. 2, 2013.
(60) Provisional application No. 61/842,153, filed on Jul. 2, 2013.

(51) Int. Cl. B23K 26/34; B23K 35/30; B23K 26/144; B23K 26/346; C23C 24/10; B23K 26/70

(52) U.S. Cl. CPC B23K 26/34; C23C 24/103; B23K 26/702; B23K 26/144; B23K 26/346; B23K 35/302

(57) ABSTRACT

A laser cladding deposited on a metal component protects the metal component against wear and tear. The laser cladding includes an alloy matrix having carbide hard particles embedded within or bonded with the alloy matrix. Induction heaters pre-heat the metal components during the laser cladding process to inhibit cracking of the alloy when the carbide particles are injected. The heaters provide simultaneous induction heating to the external surface of the metal components.

### CROSS REFERENCE TO RELATED APPLICATIONS

This application is being filed on 1 Jul. 2014, as a PCT International Patent application and claims priority to U.S. Patent Application Ser. No. 61/842,146 filed on 2 Jul. 2013 and U.S. Patent Application Ser. No. 61/842,153 filed on 2 Jul. 2013, the disclosures of which are incorporated herein by reference in their entirety.

### BACKGROUND

Offshore drilling rigs often include direct-acting tensioners to compensate for wave-induced motion. More specifically, the direct-acting tensioners may include massive hydraulic cylinders (e.g., metal components) that continuously dampen wave-induced motion and thereby balance the drilling rig.

The hydraulic cylinders are generally mounted below a deck of the drilling rig, i.e., in a splash zone, and are therefore often exposed to an extremely corrosive and wear-inducing environment from airborne salt spray, sea water, ice, moving cables, and/or debris for extended periods of time with little to no maintenance. These hydraulic cylinders can be hindered by corrosion and bio-fouling when utilized in damp environments and need to be protected against wear and tear from normal use. However, the undersea environment challenges the corrosion resistance and bio-fouling resistance of most metal materials.

Additionally, the hydraulic cylinders may undergo thousands of wear-inducing displacements and rub against multiple hydraulic cylinder seals over a service life. Consequently, such hydraulic cylinders must exhibit excellent hardness, wear-resistance, and corrosion-resistance.

### SUMMARY

The present disclosure relates to a process for laser cladding a metal component.

In accordance with some aspects of the disclosure, the laser cladding process inhibits cracking of the cladding as the cladding is applied to the metal component. In certain implementations, one or more induction heaters (e.g., heating coils) are configured to pre-heat a section of the metal component before the section is laser clad. The induction heater preheats an initial section of rod at the start of cladding. Then, the induction heater travels with the laser cladding head, maintaining sufficient preheat at all locations and post-heating the deposit. Induction heating slows the cooling rate of the cladding deposit and thereby inhibits cracking.

Reducing the amount of cracking in the cladding increases the protection of the metal component from the surrounding environment. The uncracked cladding isolates the metal component from the harsh environment.

In accordance with other aspects of the disclosure, the metal component is laser clad using an alloy matrix and carbide, ceramic, and/or intermetallic hard particles. For example, the laser cladding can include carbide hard particles either embedded within or bonded with the alloy matrix. Such an alloy matrix tends to provide wear resistance to metal components (e.g., components formed of steel, nickel-based alloys, cobalt-based alloys, copper-based alloys, etc.). In certain implementations, the laser cladding also can provide corrosion resistance and/or bio-fouling resistance.

In accordance with other aspects of the disclosure, a process for forming a cladding on a substrate includes induction heating a section of the substrate to be clad using an induction heater; directing an alloy matrix including at least about 65% by weight copper and no more than about 80% by volume of the allow matrix to the section of the substrate using a first feedstock; directing a laser beam at the section of the substrate to heat the alloy matrix to form a melt pool while the section is being induction heated; and injecting at least about 20% by volume of hard particles formers into the melt pool using a second feedstock while the section is being induction heated.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic diagram of a laser cladding system including at least one simultaneous induction heater configured to produce laser claddings as described herein;

FIG. 2 is a schematic diagram of an example cladding applied to a metal component shown in cross-section;

FIG. 3 is a schematic diagram of another example cladding applied to a metal component shown in cross-section; and

FIG. 4 illustrates an example cladding deposited on an example hydraulic cylinder.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

In some implementations, metal components can be subjected to extreme conditions (e.g., to marine environments such as submergence in salt water, proximity to water splash zones or areas that are repeatedly exposed to water due to tides and waves, or located in sea spray zones). In certain implementations, the metal components include ferrous material (e.g., steel alloys). In such conditions, protecting the metal components from the surrounding environment can be paramount. For example, water that reaches the metal components (e.g., through cracks or pores in the cladding) can result in corrosion of the substrate at the bond line and eventual spallation of the coating. Submerged metal components also can undergo bio-fouling by numerous marine organisms, such as barnacles.

The present disclosure relates to a process for laser cladding metal component. In certain implementations, the laser cladding process includes preheating a section of the metal component before the section is laser clad. The preheating helps to inhibit cracking of the cladding as the cladding is applied to the metal component. Reducing the amount of cracking in the cladding increases the protection of the metal component from the surrounding environment. The uncracked cladding isolates the metal component from the harsh environment.

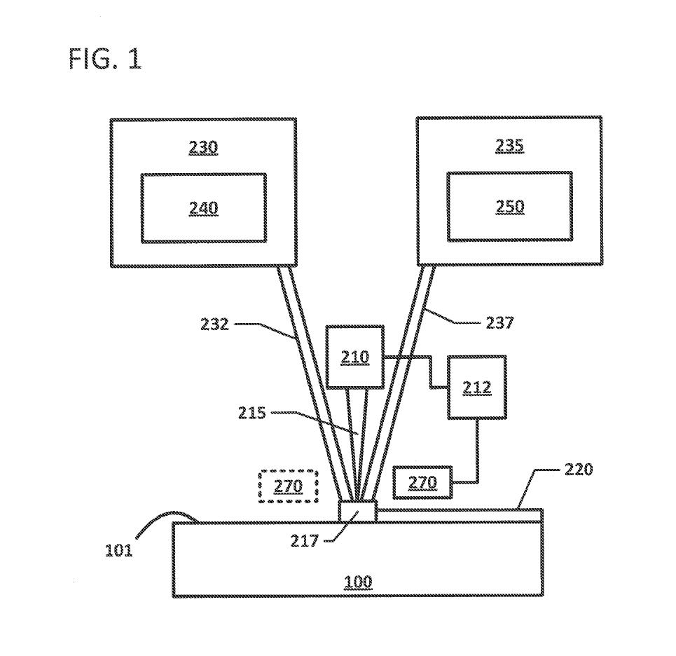

FIG. 1 is a schematic diagram illustrating a laser cladding system 200 that is used to apply a cladding 220 to the external surface 101 of a substrate 100. The cladding system 200 includes an emitter 210 that directs a laser beam 215 towards the substrate surface 101. A motion control manager 212 operates the emitter 210 to direct the laser beam 215 to selected locations along the substrate surface 101. The motion control manger 212 causes the laser beam 215 to move along the surface 101.

At least a first hopper 230 holds materials for forming an alloy matrix (e.g., powdered matrix materials) 240. In some implementations, the alloy matrix includes a nickel-based alloy. In other implementations, the alloy matrix includes a cobalt-based alloy. In still other implementations, the alloy matrix includes a copper-based alloy. The first hopper 230 includes a first nozzle 232 that directs the powder towards the substrate surface 101. The laser 215 heats the powdered materials 240 at the substrate 100 to form a melt pool 217. As the laser beam 215 moves over the substrate surface 101, the melt pool 217 left behind cools, thereby forming the cladding 220.

One or more induction heaters 270 are positioned at the substrate 100 to pre-heat the substrate surface 101 prior to cladding the surface 101. For example, one or more heating induction coils 270 can be positioned adjacent the surface 101. The heaters 270 are configured to heat the surface 101 to a temperature ranging from about 120° C. to about 900° C. In certain implementations, the substrate is pre-heated to about 400° C. to about 900° C. In certain implementations, the section is pre-heated to about 600° C. to about 900° C. In certain implementations, the substrate is pre-heated to about 600° C. to about 800° C. In certain implementations, the section is pre-heated to about 650° C. to about 800° C. In one example, the substrate is pre-heated to about 700° C.

In certain implementations, the one or more heaters 270 travel with (e.g., just ahead of) the laser beam 215 during the cladding process. For example, the motion control manager 212 may position and/or operate the heaters 270. In other implementations, heaters may be arrayed over the surface 101 and selectively turned on and off. Additional details about simultaneous induction heating can be found in U.S. Pat. No. 6,843,866, the disclosure of which is hereby incorporated herein by reference.

In accordance with some aspects of the disclosure, the preheating enables carbide, ceramic, and/or intermetallic hard particles to be injected into the alloy matrix without cracking the alloy matrix. For example, the laser cladding system 200 also includes a second hopper 235 that holds carbide content (e.g., powdered carbide materials) 250. The second hopper 235 includes a second nozzle 237 that directs the carbide content towards the substrate surface 101. In certain implementations, the carbide s 250 is directed to the substrate at the same time as the powdered matrix materials 240 so that the powdered matrix materials 240 and carbide particles 250 mix as the melt pool 217 is formed. In other implementations, the carbide particles 250 can be injected into an existing melt pool 217. In other implementations, the carbide particles 250 can be mixed with the alloy matrix 240 in a single hopper and fed together to the substrate 100.

In some implementations, the laser cladding includes no more than about 80% by volume of an alloy matrix; and at least about 20% by volume of the carbide particles. In certain implementations, the carbide particle content is at least about 30% by volume of the cladding. In certain implementations, the carbide particle content is at least about 40% by volume of the cladding. In certain implementations, the carbide particle content is at least about 50% by volume of the cladding. In certain implementations, the carbide particle content is at least about 60% by volume of the cladding.

In some implementations, the carbide hard particles include Chromium carbide particles. In other implementations, the carbide hard particles include Titanium carbide particles. In other implementations, the carbide hard particles include Vanadium carbide particles. In other implementations, the carbide hard particles include Tungsten carbide particles. In other implementations, the carbide hard particles include Zirconium carbide particles. In other implementations, the carbide hard particles include Tantalum carbide particles. In other implementations, combinations of carbide particles and alternative hard particles, including ceramics and intermetallic particles, can be used.

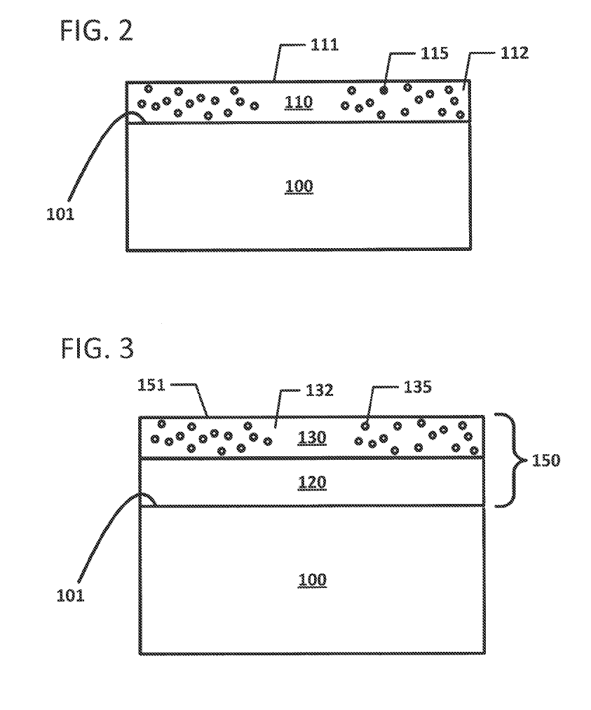

FIG. 2 illustrates one example of a substrate (e.g., a metal component) 100 that has been laser clad as disclosed above. In one example, the substrate includes a hydraulic cylinder or piston rod. In other implementations, the substrate can include any metal component. In one example, the substrate 100 includes a material less noble than copper (e.g., steel, iron, aluminum, etc.).

The cladding 110 is disposed on an external surface 101 of the substrate 100. The cladding 110 includes an alloy matrix 112 embedded with carbide hard particles 115. In alternative examples, the carbide hard particles can be bonded to the alloy matrix 112. In some implementations, the external surface 101 of the substrate 100 is isolated from the surrounding environment by the cladding 110. For example, the cladding 110 does not have cracks or other channels extending through the cladding 110 to the substrate surface 101. Accordingly, the cladding 110 is not galvanically coupled to the substrate 100.

FIG. 3 illustrates another example substrate 100 that has been laser clad as disclosed above. The cladding 150 is disposed on an external surface 101 of the substrate 100. The cladding 150 includes a first layer 120 deposited directly on the external surface 101 of the substrate 100 and a second layer 130 that is deposited on the first layer 120.

The first layer 120 provides corrosion resistance. The first layer 120 also can function as a bond coat or compliant layer to provide ductility and inhibit cracking. In some implementations, the first layer 120 includes nickel. For example, the first layer 120 can include Eatonite™ or nickel-based coatings, such as Inconel® 625.

The second layer 130 provides wear resistance and bio-fouling resistance. The second layer 130 also may provide at least some corrosion resistance. The second layer 130 includes an alloy matrix 132 bonded with carbide hard particles 135 as described above with respect to FIG. 1.

In some implementations, an external surface 151 of the cladding 150 is isolated (e.g., via the first and second layers 120, 130) from the external surface 101 of the substrate 100. For example, the cladding 150 does not have cracks or other channels extending through the cladding 150 to the substrate surface 101. In certain implementations, even if the second layer 130 cracks, the first layer 120 inhibits communication between the external surface 151 of the cladding 150 and the external surface 101 of the substrate 100.

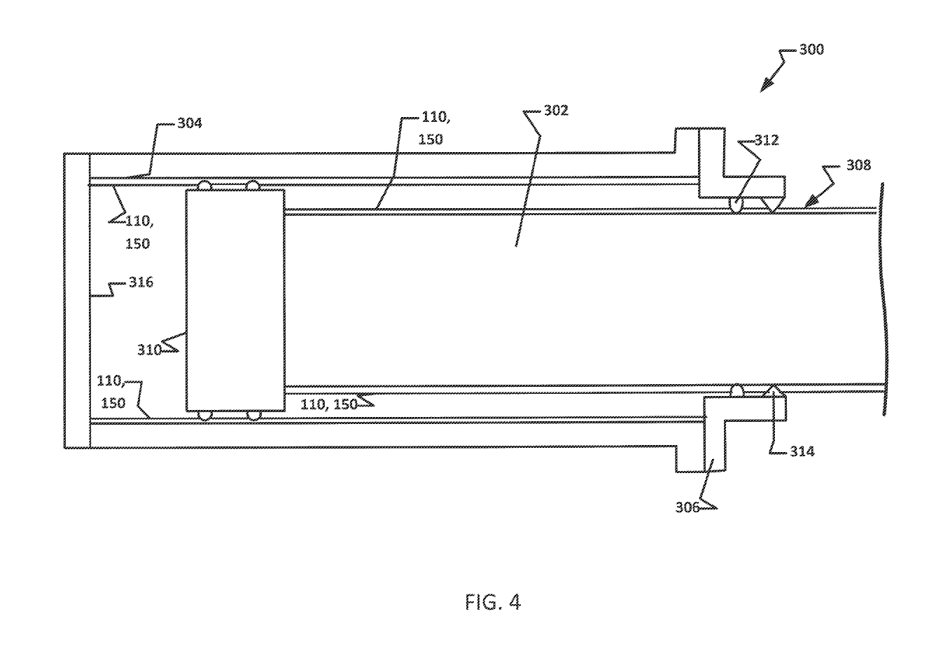

FIG. 4 illustrates one example hydraulic cylinder 300 which includes one or more components that have been laser clad as described above. In some implementations, the cylinder has a diameter ranging from about five inches to about sixteen inches. In some implementations, the cylinder has a length ranging from about seven feet to about seventy-four feet. In some implementations, the hydraulic cylinder 300 has a stroke length from twenty feet to fifty feet. In other implementations, the hydraulic cylinder 300 has a bore diameter from twelve inches to sixty inches.

The hydraulic cylinder 300 includes a piston 308 with a piston rod 302, a piston head 310, and a seal 312. In certain implementations, the hydraulic cylinder 300 includes a wiper 314 that is designed to scrape material off of the piston rod 302 before the material contacts the seal 312. In some implementations, the cladding 110 is applied to at least some portion of the piston rod 302. In certain embodiments, the laser cladding 110 is applied to other portions of the hydraulic cylinder 300. For example, the laser cladding may be applied to a cylinder barrel 304, cylinder cap 306, head 310, wiper 314, and/or seal 312 of the hydraulic cylinder 300.

In some implementations, the clad cylinder may be work hardened (e.g., by driving tungsten carbide rollers or balls against the surface). One example work hardening process is disclosed in U.S. Publication No. 2010\0173172, the disclosure of which is hereby incorporated by reference herein.

Example compositions of cladding suitable for use with the laser cladding system 200 will be described in the following examples. This cladding can be applied to any desired metallic components, such as hydraulic cylinders or other components used in wet environments.

### Example 1

A first example cladding includes a first layer and a second layer. The first layer includes Eatonite™. Alternatively, the first layer can include Inconel® 625. The second layer includes a CuSnTi alloy matrix with carbide particles bonded therein. The alloy matrix includes about 80-95% by weight of copper, about 2-10% by weight of tin, and about 1-5% by weight of titanium. In one example, the carbide particles include Chromium carbide particles. In another example, the carbide particles include Titanium carbide particles. In certain implementations, the cladding layer is electrically isolated from less noble materials that can contact an electrolyte, such as seawater. In certain implementations, the cladding is electrically insulated from more anodic materials (e.g., steel, cast iron, aluminum, or zinc).

### Example 2

A second example cladding includes only one layer. The layer includes a CuSnTi alloy matrix with carbide particles bonded therein. The alloy matrix includes about 80-95% by weight of copper, about 2-10% by weight of tin, and about 1-5% by weight of titanium. In one example, the carbide particles include Chromium carbide particles. In another example, the carbide particles include Titanium carbide particles. In certain implementations, the cladding layer is electrically isolated from less noble materials that can contact an electrolyte. In certain implementations, the cladding is electrically insulated from more anodic materials.

### Example 3

A third example cladding includes a first layer and a second layer. The first layer includes Eatonite™, Inconel® 625, or another such coating. The second layer includes a CuNi alloy matrix with hard particles. In one example, the matrix includes a 90-10 CuNi matrix. In another example, the matrix includes a 70-30 CuNi matrix. The hard particles are embedded in the matrix, but not necessarily bonded. In certain implementations, the cladding includes about 30% to about 70% by volume of the hard particles. In one example, the hard particles include Tungsten carbide.

### Example 4

A fourth example cladding includes only one layer. The layer includes a CuNi alloy matrix with carbide hard particles. In one embodiment, the matrix includes a 90-10 CuNi matrix. In another embodiment, the matrix includes a 70-30 CuNi matrix. The carbide particles are embedded in the matrix, but not necessarily bonded. In certain implementations, the cladding includes about 20% to about 60% by volume of the carbide particles. In one example, the carbide particles include Tungsten carbide.

### Example 5

A fifth example cladding includes at least one layer. The layer includes a CuNiCr alloy matrix with carbide hard particles. In certain implementations, the matrix includes at least 65% by weight of copper, at least 5% by weight of nickel, and at least 1% by weight of Chromium. In certain implementations, the matrix includes at least 70% by weight of copper, at least 10% by weight of nickel, and at least 2% by weight of Chromium. The Chromium bonds with carbon to form Chromium carbide hard particles. In certain implementations, the cladding includes about 20% to about 60% by volume of the Chromium carbide particles.

The above specification, examples and data provide a complete description of the structure, manufacture, and use of the invention. Since many embodiments of the invention can be made without departing from the spirit and scope of the invention, the invention resides in the claims hereinafter appended.

1. A method of forming on a substrate an alloy cladding including carbides, the method comprising:
induction heating a section of the substrate to be clad using an induction heater;
directing an alloy matrix including at least about 65% by weight copper and no more than about 80% by volume of the allow matrix to the section of the substrate using a first feedstock;
directing a laser beam at the section of the substrate to heat the alloy matrix to form a melt pool while the section is being induction heated; and
injecting at least about 20% by volume of hard particles formers into the melt pool using a second feedstock while the section is being induction heated.

2. The method of claim 1, wherein induction heating the section comprises induction heating the section to a temperature of about 600° C. to about 900° C.

3. The method of claim 2, wherein the temperature ranges from about 650° C. to about 750° C.

4. The method of claim 3, induction heating the section of the substrate comprises induction heating the section of the substrate to about 700° C.

5. The method of claim 1, wherein the first and second feedstocks are fed to the laser simultaneously.

6. The method of claim 1, wherein the second feedstock is fed to the laser after the first feedstock has been melted into a melt pool.

7. The method of claim 1, wherein the alloy matrix includes nickel.

8. The method of claim 1, wherein the hard particle formers include carbide.

9. The method of claim 1, wherein the first and second feedstocks include powdered feedstocks.

10. The method of claim 1, wherein the item includes a piston cylinder.

11. The method of claim 1, wherein the hard particle formers include intermetallics.

12. The method of claim 1, wherein the alloy matrix is free from cracks.

13. The method of claim 1, wherein the alloy matrix includes nickel.

14. The method of claim 13, wherein the alloy matrix includes about 65% to 95% by weight of copper and also includes about 5% to 35% by weight of nickel.

15. The method of claim 1, wherein the alloy matrix also includes no more than about 5% by weight of a carbide former, the carbide former being configured to bond carbide hard particles within the cladding.

16.-37. (canceled)

38. A method of inhibiting bio-fouling of an item for submerged service in seawater, the method comprising:
laser cladding the piston cylinder using a first feedstock and a second feedstock, the first feedstock including an alloy matrix including at least about 65% by weight copper; and the second feedstock including carbide.

39. The method of claim 38, wherein the item includes a piston cylinder.

40. The method of claim 38, wherein the first and second feedstocks are fed to the laser simultaneously.

41. The method of claim 38, wherein the second feedstock is fed to the laser after the first feedstock has been melted into a melt pool.

42. The method of claim 38, wherein the first and second feedstocks include powdered feedstocks.

43.-49. (canceled)

50. A method of forming on a substrate an alloy cladding including carbides, the method comprising:
induction heating a section of the substrate to be clad using an induction heater;
directing an alloy matrix to the section of the substrate using a first feedstock;
directing a laser beam at the section of the substrate to heat the alloy matrix to form a melt pool while the section is being induction heated; and
injecting carbide into the melt pool using a second feedstock while the section is being induction heated.

51. The method of claim 50, wherein induction heating the section comprises induction heating the section to a temperature of about 600° C. to about 900° C.

52. The method of claim 51, wherein the temperature ranges from about 650° C. to about 750° C.

53. The method of claim 52, induction heating the section of the substrate comprises induction heating the section of the substrate to about 700° C.

54. The method of claim 50, wherein the first and second feedstocks are fed to the laser simultaneously.

55. The method of claim 50, wherein the second feedstock is fed to the laser after the first feedstock has been melted into a melt pool.

56. The method of claim 50, wherein the alloy matrix includes nickel.

57. The method of claim 50, wherein the alloy matrix includes copper.

58. The method of claim 50, wherein the alloy matrix includes cobalt.

59. The method of claim 50, wherein the item includes a piston cylinder.

60. A method for forming a cladding on a substrate, the method comprising:
using a laser to form a melt pool on the substrate, the melt pool including a cladding material and the melt pool being formed at a laser heating location on the substrate;
generating relative movement between the laser and the substrate such that the laser heating location moves forwardly along the substrate; and
inductively heating the substrate in front of the laser heating location and behind the laser heating location.

61. The method of claim 60, wherein the melt pool includes an alloy matrix.

62. The method of claim 61, wherein hard particles are disposed within the melt pool.

63. The method of claim 61, wherein the hard particles include carbide particles.
